(19) United States
(12) Patent Application Publication
(10) Pub. No.: US 2025/0167212 A1
(43) Pub. Date: May 22, 2025

(54) METHOD FOR PRODUCING NICKEL METAL HYDRIDE BATTERY, POSITIVE ELECTRODE FOR NICKEL METAL HYDRIDE BATTERIES, AND NICKEL METAL HYDRIDE BATTERY

(71) Applicants: KABUSHIKI KAISHA TOYOTA JIDOSHOKKI, Kariya-shi, Aichi-ken (JP); TOYOTA JIDOSHA KABUSHIKI KAISHA, Toyota-shi, Aichi-ken (JP)

(72) Inventors: Hiroyuki SASAKI, Kariya-shi (JP); Satoshi KONO, Kariya-shi (JP); Shuhei MOCHIDA, Kariya-shi (JP); Keisuke SHIRAI, Kariya-shi (JP); Norifumi YOSHIDA, Kariya-shi (JP); Yoshifumi ISHIKAWA, Kariya-shi (JP); Takeo OKANISHI, Kariya-shi (JP); Daiki TERASHIMA, Okazaki-shi (JP); Masanobu OUCHI, Toyota-shi (JP); Hiroyuki KAIYA, Toyota-shi (JP); Motoyoshi OKUMURA, Nagoya-shi (JP); Hiroyuki NAKANO, Nagoya-shi (JP)

(73) Assignees: KABUSHIKI KAISHA TOYOTA JIDOSHOKKI, Kariya-shi, Aichi-ken (JP); TOYOTA JIDOSHA KABUSHIKI KAISHA, Toyota-shi, Aichi-ken (JP)

(21) Appl. No.: 18/730,434

(22) PCT Filed: Jan. 24, 2023
(86) PCT No.: PCT/JP2023/001995

§ 371 Date: Jul. 19, 2024

(30) Foreign Application Priority Data
Jan. 25, 2022 (JP) 2022-009261

(51) Int. Cl. H01M 4/32; H01M 4/02; H01M 4/04; H01M 4/26; H01M 4/36; H01M 4/52; H01M 4/62; H01M 10/34

(52) U.S. Cl. CPC H01M 4/32; H01M 4/0404; H01M 4/26; H01M 4/366; H01M 4/52; H01M 4/625; H01M 4/626; H01M 10/345; H01M 2004/027; H01M 2004/028

(57) ABSTRACT

A method for producing a nickel metal hydride battery includes a positive electrode producing step of layering a raw material composition including a positive electrode active material powder containing nickel hydroxide, a cobalt compound, and flake graphite, on a current collector to produce a positive electrode including a positive electrode active material layer in which a graphitization degree is 0.4 or less as measured by Raman spectroscopy. The method further includes a negative electrode producing step of layering a raw material composition including a negative electrode active material powder on a current collector to produce a negative electrode, an electrode body producing step of arranging a separator between the positive electrode and the negative electrode and impregnating the separator with an electrolytic solution to produce an electrode body, and an overdischarging step of charging, overdischarging, and again charging the electrode body.

### TECHNICAL FIELD

The present invention relates to a method for producing a nickel metal hydride battery, a positive electrode for a nickel metal hydride battery, and a nickel metal hydride battery.

### BACKGROUND ART

Patent Literature 1 describes a pasted nickel electrode for a storage battery containing an alkaline electrolyte. The pasted nickel electrode includes an active material based on nickel hydroxide and a conductor based on carbon. Patent Literature 1 also describes that a cobalt compound such as metal cobalt, cobalt hydroxide, or cobalt oxide is added to improve the conductivity of the pasted nickel electrode.

### CITATION LIST

### Patent Literature

Patent Literature 1: Japanese Laid-Open Patent Publication No. 11-273672

### SUMMARY OF INVENTION

### Technical Problem

A cobalt compound is an expensive material and a limited resource. Therefore, it is desirable that the content of the cobalt compound used in an electrode is reduced. Examples of materials alternative to the cobalt compound include a carbon material. However, when a carbon material is used as an alternative to the cobalt compound, the carbon material may corrode. Corrosion of the carbon material may increase cell resistance.

### Solution to Problem

To solve the problem described above, a method for producing a nickel metal hydride battery includes a positive electrode producing step of layering a raw material composition, the raw material composition including a positive electrode active material powder containing nickel hydroxide, a cobalt compound, and flake graphite, on a current collector to produce a positive electrode including a positive electrode active material layer in which a content of the cobalt compound is less than or equal to 3 mass % and a graphitization degree is less than or equal to 0.4 as measured by Raman spectroscopy, a negative electrode producing step of layering a raw material composition including a negative electrode active material powder on a current collector to produce a negative electrode, an electrode body producing step of arranging a separator between the positive electrode and the negative electrode and impregnating the separator with an electrolytic solution to produce an electrode body, and an overdischarging step of, after charging the electrode body, overdischarging the electrode body, and again charging the electrode body.

To solve the problem described above, in the method, in the raw material composition, an average particle size of the flake graphite is greater than or equal to 0.4 times an average particle size of the positive electrode active material powder.

To solve the problem described above, a positive electrode for a nickel metal hydride battery includes a current collector and a positive electrode active material layer. The positive electrode active material layer includes a positive electrode active material, a cobalt compound layer covering the positive electrode active material, and flake graphite. A content of a cobalt compound in the positive electrode active material layer is less than or equal to 3 mass %. A coverage of the cobalt compound layer on the positive electrode active material is greater than or equal to 50%. The positive electrode active material layer has a graphitization degree that is less than or equal to 0.4 as measured by Raman spectroscopy.

To solve the problem described above, in the positive electrode, the cobalt compound layer has an average thickness that is less than or equal to 10 nm.

To solve the problem described above, in the positive electrode, an average particle size of the flake graphite is greater than or equal to 0.3 times an average particle size of the positive electrode active material.

To solve the problem described above, in the positive electrode, a content of the flake graphite in the positive electrode active material layer is greater than or equal to 3 mass % and less than or equal to 10 mass %.

To solve the problem described above, in the positive electrode, the cobalt compound layer is further formed on a surface of the flake graphite.

To solve the problem described above, a nickel metal hydride battery includes the positive electrode described above.

### Advantageous Effects of Invention

The present invention limits an increase in cell resistance while appropriately reducing the content of the cobalt compound in the positive electrode active material layer.

### BRIEF DESCRIPTION OF DRAWINGS

FIG. 1 is a cross-sectional view of a nickel metal hydride battery.

FIG. 2 is an electron micrograph of a positive electrode active material layer before and after initial charging.

FIG. 3 is a schematic diagram showing a deposition mechanism of cobalt oxyhydroxide at the time of initial charging.

FIG. 4 is a graph showing the dissolution potential of cobalt oxyhydroxide.

FIG. 5 is a graph showing potentials at the time of normal discharging and at the time of overdischarging.

FIG. 6 is a schematic diagram showing a deposition mechanism of cobalt hydroxide during an overdischarging step.

FIG. 7 is an electron micrograph of the positive electrode active material layer after the overdischarging step.

### DESCRIPTION OF EMBODIMENTS

An embodiment of the present invention will now be described with reference to the drawings.

An electrode body, which is included in a nickel metal hydride battery, will now be described.

### Electrode Body

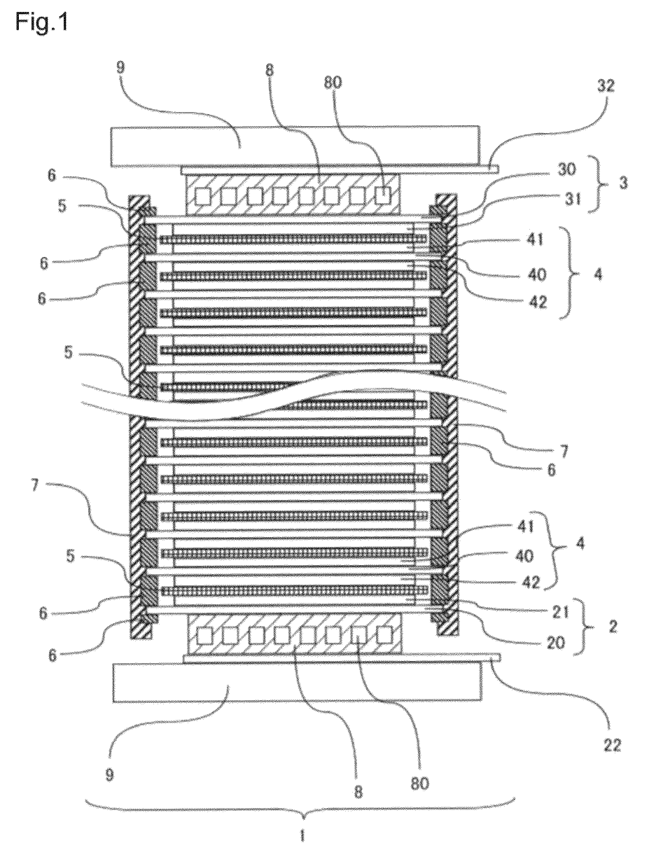

As shown in FIG. 1, a nickel metal hydride battery 1 includes a positive electrode for a nickel metal hydride battery 2 (hereafter, may be simply referred to as “positive electrode”) that includes a current collector foil 20, which is used as a current collector, and a positive electrode active material layer 21. The positive electrode active material layer 21 is layered on one surface of the current collector foil 20.

The nickel metal hydride battery 1 includes a negative electrode for a nickel metal hydride 3 (hereafter, may be simply referred to as “negative electrode”) that includes a current collector foil 30, which is used as a current collector, and a negative electrode active material layer 31. The negative electrode active material layer 31 is layered on the other surface of the current collector foil 30.

The nickel metal hydride battery 1 includes a hyperbolic electrode 4 including a current collector foil 40 as a current collector, a positive electrode active material layer 41 layered on one surface of the current collector foil 40, and a negative electrode active material layer 42 layered on the other surface of the current collector foil 40. In the description, “one side” refers to the upper side in FIG. 1, and “the other side” refers to the lower side in FIG. 1.

As shown in FIG. 1, multiple hyperbolic electrodes 4 are layered on one another with separators 5 located in between. More specifically, the positive electrode active material layer 41 of one hyperbolic electrode 4 is opposed to and stacked on the negative electrode active material layer 42 of another hyperbolic electrode 4 with the separator 5 located in between. The stacking is repeated in the hyperbolic electrode 4.

The negative electrode active material layer 42 of one of the hyperbolic electrodes 4 is layered on a surface of the positive electrode active material layer 21 of the positive electrode 2 with a separator 5. Also, the positive electrode active material layer 41 of one of the hyperbolic electrodes 4 is layered on a surface of the negative electrode active material layer 31 of the negative electrode 3 with a separator 5. In other words, the separators 5 are each arranged between the positive electrode 2, the negative electrode 3, and the hyperbolic electrodes 4. In a stacking direction of the hyperbolic electrodes 4, the negative electrode 3 is arranged at one end, and the positive electrode 2 is arranged at the other end.

The separators 5 are impregnated with an electrolytic solution. The positive electrode 2, the negative electrode 3, and the hyperbolic electrodes 4 are stacked on one another with the separators 5 located in between to form an electrode body. The electrode body is also referred to as a battery module.

### Nickel Metal Hydride Battery

As shown in FIG. 1, the battery module includes the current collector foils 20, 30, 40 having the same shape. Also, the battery module includes the separators 5 having the same shape. The current collector foils 20, 30, and 40 are greater in size than the positive electrode active material layers 21 and 41, the negative electrode active material layers 31 and 42, and the separators 5. The separators 5 are greater in size than the positive electrode active material layers 21 and 41 and the negative electrode active material layers 31 and 42.

As shown in FIG. 1, the current collector foils 20, 30, and 40 each include a peripheral edge fixed to an outer frame 7 formed from a synthetic resin. Fluoropolymer sealing members 6 are arranged at an inner side of the outer frame 7. The sealing members 6 are arranged at opposite surfaces, that is, one surface and the other surface, of the current collector foils 20, 30, and 40 and bonded to the peripheral edges of the current collector foils 20, 30, and 40. When the sealing members 6 are bonded to the peripheral edges of the current collector foils 20, 30, and 40, the spaces between the current collector foils 20, 30, and 40 are hermetically sealed.

As shown in FIG. 1, two cooling members 8 are arranged at one end and the other end of the battery module. More specifically, one of the cooling members 8 is arranged on the current collector foil 20 of the positive electrode 2, which is included in the battery module. The other one of the cooling members 8 is arranged on the current collector foil 30 of the negative electrode 3, which is included in the battery module. The two cooling members 8 each have the form of a plate having through holes 80.

A positive module electrode 22 is arranged on one of the two cooling members 8 that is arranged on the current collector foil 20 of the positive electrode 2. A negative module electrode 32 is arranged on one of the two cooling members 8 that is arranged on the current collector foil 30 of the negative electrode 3. The positive module electrode 22 and the negative module electrode 32 are formed of a rectangular metal plate.

As shown in FIG. 1, two fasteners 9 are arranged on the positive module electrode 22 and the negative module electrode 32. The two fasteners 9 are fastened by bolts and nuts, which are not shown in the drawing. The fasteners 9 apply pressure to the battery module in a thickness-wise direction of the positive electrode 2, the negative electrode 3, and the hyperbolic electrodes 4. The two cooling members 8, the positive module electrode 22, and the negative module electrode 32 are arranged in the battery module and fastened by the two fasteners 9 to form the nickel metal hydride battery 1. The nickel metal hydride battery 1 including the hyperbolic electrodes 4 is also referred to as a hyperbolic nickel metal hydride battery or a bipolar metal hydride battery.

The positive electrode 2, the negative electrode 3, the hyperbolic electrode 4, and the separators 5 will now be described.

### Positive Electrode

The positive electrode 2 includes the current collector foil 20, as a current collector, and the positive electrode active material layer 21.

### Current Collector

The current collector is an inert electrical conductor. During the charging and discharging of the nickel metal hydride battery, the current collector continuously provides current to the positive electrode active material layer 21.

The material of the current collector is not particularly limited and includes, for example, silver, copper, gold, aluminum, tungsten, cobalt, zinc, nickel, iron, platinum, tin, indium, titanium, ruthenium, tantalum, chromium, and molybdenum.

As the current collector, only one of the materials described above may be used, or two or more of the materials may be used in combination. When two or more of the materials are used in combination, the materials may be used as a solid solution or an alloy. For example, stainless steel may be used.

The shape of the current collector is not limited to a foil. An appropriate shape allowing current to flow to the positive electrode active material layer 21 may be selected. The shape of the current collector other than a foil is, for example, a sheet, a film, a linear shape, a rod, a mesh, or a sponge.

Among the shapes described above, the foil, the sheet, and the film easily increase the area of contact with the positive electrode active material layer 21 and the positive module electrode 22 and thus are preferred.

The thickness of the current collector is not particularly limited. The thickness of the current collector is preferably, for example, greater than or equal to 1 μm and less than or equal to 100 μm.

### Positive Electrode Active Material Layer

The positive electrode active material layer 21 includes positive electrode active material powder containing nickel hydroxide or high-order nickel hydroxide in which the average valence of nickel is greater than two, a cobalt compound layer covering the positive electrode active material powder, and flake graphite. The content of the cobalt compound in the positive electrode active material layer is less than or equal to 3 mass %. The coverage of the cobalt compound layer on the positive electrode active material layer is greater than or equal to 50%. The positive electrode active material layer 21 has a graphitization degree that is less than or equal to 0.4 as measured by Raman spectroscopy. The positive electrode active material powder containing the nickel hydroxide or high-order nickel hydroxide described above is also simply referred to as a positive electrode active material.

The nickel hydroxide may be doped with a metal other than nickel. Examples of metal other than nickel include elements in group 2 such as magnesium and calcium, elements in group 9 such as cobalt, rhodium, and iridium, and elements in group 12 such as zinc and cadmium.

The particle size of the nickel hydroxide is not particularly limited. However, it is preferred that the average particle size is greater than or equal to 3 μm and less than or equal to 40 μm. It is more preferred that the average particle size is greater than or equal to 5 μm and less than or equal to 30 μm. It is further preferred that the average particle size is greater than or equal to 7 μm and less than or equal to 20 μm.

The content of nickel hydroxide in the positive electrode active material layer 21 is not particularly limited, but is preferred to be greater than or equal to 75 mass % and less than or equal to 98 mass %. It is more preferred that the content of nickel hydroxide is greater than or equal to 85 mass % and less than or equal to 95 mass %.

The cobalt compound forming the cobalt compound layer is not particularly limited as long as the cobalt compound has a high conductivity. For example, a high-order cobalt oxide such as cobalt oxyhydroxide (CoOOH) may be used. Cobalt oxyhydroxide (CoOOH) is used as a conductive additive.

Preferably, the cobalt compound layer covering the positive electrode active material has an average thickness that is less than or equal to 10 nm. The average thickness of the cobalt compound layer is more preferably less than or equal to 8 nm and further preferably less than or equal to 6 nm. The lower limit of the average thickness of the cobalt compound layer is not particularly limited. The lower limit may be appropriately set in a range in which the function of the conductive additive is maintained. The average thickness of the cobalt compound layer is preferably greater than or equal to 0.5 nm and more preferably greater than or equal to 1 nm.

When the average thickness of the cobalt compound layer is in the range of the numerical values described above, the content of the cobalt compound in the positive electrode active material layer 21 is appropriately reduced while the function of the conductive additive is maintained.

The average thickness of the cobalt compound layer may be measured by observation using a known technique such as TEM-EELS.

The coverage of the cobalt compound layer on the positive electrode active material is preferably 70% or greater, 80% or greater, 85% or greater, 90% or greater, or 95% or greater.

The coverage of the cobalt compound layer on the positive electrode active material refers to the proportion of the cobalt compound layer on the surface of the positive electrode active material. When the surface of the positive electrode active material is completely covered by the cobalt compound layer, the coverage is 100%. The coverage of the cobalt compound layer on the positive electrode active material may be measured by observation using TEM-EELS or the like.

The content of the cobalt compound in the positive electrode active material layer 21 is preferably less than or equal to 2.5 mass %. In addition, the content of the cobalt compound is preferably greater than or equal to 0.4 mass %, more preferably greater than or equal to 0.5 mass %, and further preferably greater than or equal to 1 mass %.

When the content of the cobalt compound is within the range of the numerical values described above, the average thickness of the cobalt compound layer is easily set to 10 nm or less when the cobalt compound layer is formed on the positive electrode active material by the process described below. In addition, the battery has a capacity utilization rate greater than or equal to 90%, indicating a preferred battery property.

The flake graphite is used as a conductive additive. The flake graphite is not particularly limited. A known flake graphite may be used.

The flake graphite has a thickness t, which is the dimension in a stacking direction of a six-membered ring of graphite, and a diameter r, which is the largest dimension in a direction along the surface of the six-membered ring, in other words, the longitudinal dimension. The flake graphite satisfies the following relations.

Relations: r/t>1, t<1 μm

The diameter r is considered as the particle size of the flake graphite. The diameter r is greater than the thickness t. Thus, the flake graphite has a low-profile shape as a whole. The flake graphite is also referred to as nanographene.

The average value of the diameter r of the flake graphite is referred to as an average particle size. The average particle size is preferably 25 μm or less, 20 μm or less, 15 μm or less, 10 μm or less, 8 μm or less, or 7 μm or less. The average particle size of the flake graphite is preferably 1 μm or greater, 3 μm or greater, or 5 μm or greater.

In addition, the average particle size of the flake graphite is preferably greater than or equal to 0.3 times the average particle size of the positive electrode active material and is preferably greater than or equal to 0.5 times. The average particle size of the flake graphite is preferably less than or equal to three times, two times, or 1.5 times the average particle size of the positive electrode active material. More preferably, the average particle size of the flake graphite is less than or equal to 1.25 times the average particle size of the positive electrode active material.

When the average particle size of the flake graphite is greater than or equal to 0.3 times the average particle size of the positive electrode active material, the particle size of the flake graphite will not be excessively small compared to the particle size of the positive electrode active material and thus has a specified size. Therefore, in the positive electrode active material layer 21, the flake graphite extends over multiple particles of the positive electrode active material. In other words, the flake graphite is in contact with multiple particles of the positive electrode active material. This ensures a conductive path, thereby limiting an increase in the internal resistance of the positive electrode active material layer 21.

When the average particle size of the flake graphite is less than or equal to three times the average particle size of the positive electrode active material and the content of the flake graphite is fixed, a greater number of particles of the flake graphite may be contained. This ensures a greater number of conductive paths, thereby limiting an increase in the internal resistance of the positive electrode active material layer 21.

The particle size of the flake graphite may be measured by observation with a known scanning electron microscope.

The flake graphite preferably has a graphitization degree of 0.3 or less, more preferably 0.25 or less, as measured by Raman spectroscopy. A process for evaluating the graphitization degree will be described later.

The specific surface area of the flake graphite is preferably 20 m²/g or less, 15 m²/g or less, 10 m²/g or less, or 5 m²/g or less. When the specific surface area of the flake graphite is small, the rate of carbon bonding deficit is likely to be decreased. Thus, as the specific surface area of the flake graphite is decreased, the reactivity is likely to be decreased.

The specific surface area of the flake graphite may be measured by using, for example, a B.E.T process. The B.E.T specific surface area may be determined by measuring an adsorption-desorption isotherm with nitrogen gas using a specific surface area and pore size analyzer (QUADRASORB evo, manufactured by Anton Paar GmbH) and using a single-point method.

The content of the flake graphite in the positive electrode active material layer 21 is not particularly limited and is preferably greater than or equal to 1 mass % and less than or equal to 10 mass %, more preferably, greater than or equal to 1 mass % and less than or equal to 8 mass %, and further preferably, greater than or equal to 3 mass % and less than or equal to 8 mass %.

When the content of the flake graphite is within the range of the numerical values described above, the conductivity may be improved while maintaining the necessary amount of the positive electrode active material and the cobalt compound in the positive electrode active material layer 21.

The positive electrode active material layer 21 has the graphitization degree that is less than or equal to 0.4 as measured by Raman spectroscopy. Preferably, the graphitization degree of the positive electrode active material layer 21 is less than or equal to 0.3 as measured by Raman spectroscopy.

### Evaluation of GraphitizationDegree Using Raman Spectroscopy

In Raman spectroscopy, the intensity IG of a peak detected at 1580 to 1620 cm⁻¹ is derived from graphite and is called the G-Band. In Raman spectroscopy, the intensity ID of a peak detected at 1300 to 1400 cm⁻¹ is derived from the carbon bonding deficit and is referred to as the D-Band. The intensity of each peak may refer to the height of the peak or the area of the peak.

It is preferred that the ratio R of the intensity ID to the intensity IG is small. The reason is as follows. The above-described R is referred to as a graphitization degree (hereafter, also referred to as R value).

When the positive electrode includes a conductive additive formed of carbon, the battery resistance is relatively high. This may be because the conductive additive formed of carbon contained in the positive electrode is decomposed to produce substances such as CO and CO₂ at the time of charging and discharging. Also, the conductive additive formed of carbon is considered to have a bonding deficit portion having a high reactivity. Hence, when the R value of the conductive additive formed of carbon is small, which means that the rate of the bonding deficit is low, the reactivity is lower than when the R value of the conductive additive formed of carbon is larger. The conductive additive formed of carbon having a small R value has a higher resistance to decomposition. This limits production of substances that cause the battery resistance to increase. Thus, the positive electrode including the conductive additive formed of carbon and having a small R value may limit improvement of the battery resistance.

When the R value of the flake graphite is less than or equal to 0.3, corrosion of the conductive additive formed of carbon, or the flake graphite, is limited. Also, when the R value of the positive electrode active material layer 21 is less than or equal to 0.4, corrosion of the flake graphite is limited. This limits increases in the cell resistance.

The ratio R of ID/IG, which is the graphitization degree of the flake graphite, is not particularly limited to a range of numerical values. Examples of the ratio R include 0≤ ID/IG<0.4, 0<ID/IG≤0.3, 0<ID/IG≤0.25, 0.002≤ID/IG≤0.2, 0.002≤ID/IG≤0.15, 0.002≤ID/IG≤0.14, 0.05≤ID/IG≤0.2, 0.08≤ID/IG≤0.15, and 0.1≤ID/I≤0.14.

The reactivity of the flake graphite may be evaluated using a numeral value obtained by multiplying the R value of the flake graphite and the B.E.T specific surface area (m²/g). The numerical value obtained by multiplying the R value of the flake graphite and the B.E.T specific surface area (m²/g) is preferably 3.0 or less, 2.5 or less, 2.0 or less, 1.5 or less, 1.0 or less, or 0.5 or less.

### Other Components

The positive electrode active material layer 21 may include other components in addition to the positive electrode active material including nickel hydroxide, the cobalt compound layer covering the positive electrode active material, and the flake graphite.

Such components include a conductive additive other than the flake graphite, a binder, an additive, and an antioxidant.

The conductive additive other than the flake graphite is not particularly limited and includes, for example, acetylene black and carbon black.

The content of the conductive additive other than the flake graphite is not particularly limited, but is preferably less than the content of the flake graphite, and is more preferably less than or equal to one half of the content of the flake graphite. The content of the conductive additive other than the flake graphite is preferably less than or equal to 5 mass %, more preferably, less than or equal to 3 mass %, and further preferably, less than or equal to 2 mass %.

The binder binds the material included in the positive electrode active material layer 21 to the surface of the current collector.

The binder is not particularly limited. A binder for an electrode of a nickel metal hydride battery may be used.

Specific examples of the binder include fluorine-containing resins such as polyvinylidene fluoride, polytetrafluoroethylene, and fluoropolymer; polyolefin resins such as polypropylene and polyethylene; imide resins such as polyimide and polyamide-imide; cellulose derivatives such as carboxymethyl cellulose, methyl cellulose, and hydroxypropyl cellulose; copolymers such as styrene-butadiene rubber; and (meth)acrylic resins such as polyacrylic acid containing (meth)acrylic acid derivatives as monomer units, polyacrylic esters, polymethacrylic acid, and polymethacrylic ester.

The content of the binder is not particularly limited, however is preferably greater than or equal to 0.1 mass % and less than or equal to 15 mass %, more preferably greater than or equal to 0.3 mass % and less than or equal to 10 mass %, and further preferably greater than or equal to 0.5 mass % and less than or equal to 7 mass %.

Specific examples of the additive include zinc oxide and yttrium oxide.

The content of the additive is not particularly limited, however is preferably greater than or equal to 0.05 mass % and less than or equal to 5 mass %, more preferably greater than or equal to 0.1 mass % and less than or equal to 10 mass %, and further preferably greater than or equal to 0.1 mass % and less than or equal to 5 mass %.

The antioxidant is not particularly limited. A known antioxidant may be used. Specific examples of the antioxidant include a phosphorus-based antioxidant, an amine-based antioxidant, a sulfur-based antioxidant, and a phenol-based antioxidant.

One type of the materials described above may be used alone. Two or more types of the materials may be used in combination. A phosphorus-based antioxidant and a phenol-based antioxidant may be used in combination. The self-discharge property of an amine-based antioxidant may be deteriorated by the shuttle effect of a nitrogen compound. Hence, it is preferred that the amine-based antioxidant is contained in a small amount or is not contained.

The content of the antioxidant is not particularly limited, however is preferably greater than or equal to 0.1 mass % and less than or equal to 5 mass %, more preferably greater than or equal to 0.3 mass % and less than or equal to 2 mass %, and further preferably greater than or equal to 0.5 mass % and less than or equal to 1 mass %.

The total content of the other components is not particularly limited, however is preferably 15 mass % or less, more preferably 10 mass % or less, and further preferably 7 mass % or less.

In the present disclosure, the positive electrode active material layer 21 does not include a positive electrode active material layer that is produced using, as a raw material, nickel hydroxide particles precoated with a cobalt compound.

### Negative Electrode

The negative electrode 3 includes the current collector foil 30, as a current collector, and the negative electrode active material layer 31.

### Current Collector

The material and shape of the current collector are not particularly limited. The material and shape may be the same as those used in the positive electrode.

### Negative Electrode Active Material Layer

The negative electrode active material layer 31 includes a hydrogen storage alloy as a negative electrode active material.

The hydrogen storage alloy is an alloy of metal A that is highly reactive with hydrogen but has inferior hydrogen release capability and metal B that is less reactive with hydrogen but has superior hydrogen release capability.

The hydrogen storage alloy is not particularly limited. An alloy appropriate to the negative electrode active material of a nickel metal hydride battery may be used.

Specific examples of metal A include elements in group 2 such as Mg, elements in group 3 such as Sc and lanthanoid, elements in group 4 such as Ti and Zr, elements in group 5 such as V and Ta, mischmetal including rare-earth elements (hereinafter, may be abbreviated as Mm), and Pd.

Specific examples of metal B include Fe, Co, Ni, Cr, Pt, Cu, Ag, Mn, Zn, and Al.

Specific examples of the hydrogen storage alloy include an AB₅ type having a crystal structure of hexagonal CaCu₅, an AB₂ type having a crystal structure of hexagonal MgZn₂ or cubic MgCu₂, an AB type having a crystal structure of cubic CsCl, an A₂B type having a crystal structure of hexagonal Mg₂Ni, a solid solution type having body-centered cubic structure, and an AB₃ type, an A₂B₇ type, and an A₅B₁₉ type, each of which is a combination of crystal structures of an AB₅ type and an AB₂ type.

The hydrogen storage alloy may have only one type of the above crystal structures or two or more type of the above crystal structures. In each crystal structure, some of metals may be substituted with one or more types of other metals or elements.

The particle size of the hydrogen storage alloy is not particularly limited. The average particle size of the hydrogen storage alloy is preferably greater than or equal to 1 μm and less than or equal to 40 μm, more preferably greater than or equal to 3 μm and less than or equal to 30 μm, and further preferably greater than or equal to 4 μm and less than or equal to 20 μm. The average particle size is further preferably greater than or equal to 5 μm and less than or equal to 15 μm, and most preferably greater than or equal to 5 μm and less than or equal to 12 μm.

In the same manner as the positive electrode active material layer 21, the negative electrode active material layer 31 may include other components such as a conductive additive and a binder. The negative electrode active material may include a hydrogen storage alloy having an oxidized surface.

### Hyperbolic Electrode

The hyperbolic electrode 4 includes the current collector foil 40 as a current collector, the positive electrode active material layer 41 layered on one surface of the current collector foil 40, and the negative electrode active material layer 42 layered on the other surface of the current collector foil 40.

The material and the shape of the current collector foil 40, the positive electrode active material layer 41, and the negative electrode active material layer 42 may be the same as those used in the positive electrode 2 and the negative electrode 3. The hyperbolic electrode 4 is also referred to as a bipolar electrode.

### Separator

The separators 5 separate the positive electrode 2, the negative electrode 3, and the hyperbolic electrode 4 to prevent the electrodes from contacting each other, which would form a short circuit. The separators 5 also provide a storage space and a passage for an electrolytic solution.

The material of the separators 5 is not particularly limited. A known material may be used appropriately.

Specific examples of the material of the separators 5 include a porous body, a non-woven fabric, and a woven fabric formed from an electrically insulating materials, for example, synthetic resins such as polytetrafluoroethylene, polypropylene, polyethylene, polyimide, polyamide, polyaramid, polyester, and polyacrylonitrile; polysaccharides such as cellulose and amylose; natural polymers such as fibroin, keratin, lignin, and suberin; and ceramics.

As the separators 5, only one of the materials described above may be used, or two or more of the materials may be used in combination.

The separators 5 are impregnated with an electrolytic solution that is a solution in which alkali metal hydroxide is dissolved. Examples of the alkali metal hydroxide include lithium hydroxide, sodium hydroxide, and potassium hydroxide.

As the alkali metal hydroxide, only one of the materials described above may be used, or two or more of the materials may be used in combination. However, it is preferred that the alkali metal hydroxide includes all of the three materials.

### Method for Producing Nickel Metal Hydride Battery

The method for producing the nickel metal hydride battery 1 includes a positive electrode producing step, a negative electrode producing step, a hyperbolic electrode producing step, an electrode body producing step, and an overdischarging step.

Each of the steps will now be described.

### Positive Electrode Producing Step

The positive electrode producing step includes layering a raw material composition that includes the positive electrode active material powder including nickel hydroxide, the cobalt compound such as metal cobalt, and the flake graphite on the current collector foil 20 to produce the positive electrode 2 including the positive electrode active material layer 21 having an R value that is less than or equal to 0.4.

The process of layering the raw material composition on the current collector foil 20 is not particularly limited. In an example of the layering process, the raw material composition may be kneaded, and the kneaded raw material composition may be applied to the current collector foil 20. In another example of the layering process, the kneaded raw material composition may be applied to a known transfer sheet. The raw material composition may be attached to the current collector foil 20 with the transfer sheet. Then, the transfer sheet may be removed. In another example of the layering process, the kneaded raw material composition may be shaped as a sheet, and then the sheet of the raw material composition may be attached to the current collector foil 20. In the positive electrode producing step, other components such as a known solvent, a binder, and an additive may be added to the raw material composition. In addition, a step of drying the raw material composition may be included.

The raw material composition may be kneaded using a known kneader. A kneading condition may be changed to adjust the average particle size of the flake graphite in the raw material composition in a state after the kneading. The kneading condition includes, for example, shear force.

In the raw material composition, the average particle size of the flake graphite is preferably greater than or equal to 0.4 times the average particle size of the positive electrode active material powder. When the average particle size of the flake graphite is greater than or equal to 0.4 times the average particle size of the positive electrode active material and the raw material composition is kneaded, a situation in which the particle size of the flake graphite becomes excessively small compared to the particle size of the positive electrode active material is likely to be avoided.

### Negative Electrode Producing Process

The negative electrode producing step includes layering a raw material composition including a negative electrode active material powder on the current collector foil 30 to produce the negative electrode 3. The negative electrode producing step may be performed in the same manner as the positive electrode producing step.

### Hyperbolic Electrode Producing Step

The hyperbolic electrode producing step includes layering a raw material composition including the positive electrode active material on one surface of the current collector foil 40 to produce a positive electrode and layering a raw material composition including the negative electrode active material powder on the other surface of the current collector foil 40 to produce a negative electrode. The positive electrode and the negative electrode may be produced in the same process as the positive electrode producing step and the negative electrode producing step.

### Electrode Body Producing Step

The electrode body producing step includes sandwiching the separators 5 between the positive electrode 2, the negative electrode 3, and the hyperbolic electrodes 4 and impregnating the separators 5 with the electrolytic solution to produce the electrode body. In the electrode body, the separators 5 are arranged between the positive electrode 2, the negative electrode 3, and the hyperbolic electrodes 4. The hyperbolic electrodes 4 function as a positive electrode and a negative electrode. Hence, in other words, in the electrode body, the separators 5 are arranged between the positive electrodes and the negative electrodes.

### Overdischarging Step

The overdischarging step includes, after charging the electrode body, overdischarging and then again charging the electrode body.

In the overdischarging step, the electrode body is first charged. The electrode body is charged at a cell voltage of 1 V or higher.

Then, the electrode body is overdischarged. In the overdischarging step, the cell voltage is preferably greater than or equal to 0.2 V and less than 1.0 V, and more preferably greater than or equal to 0.7 V and less than 1.0 V.

The cell voltage may be converted into a positive electrode potential (V vs. Hg/HgO). That is, in the overdischarging step, a preferred range may be expressed by the positive electrode potential. In the overdischarging step, the positive electrode potential is preferably greater than or equal to −0.6 V and less than 0.2 V, and more preferably greater than or equal to −0.1 V and less than 0.2 V.

When overdischarging is performed and then charging is again performed until the cell voltage becomes greater than or equal to 1 V, cobalt hydroxide selectively deposits on the positive electrode active material. As a result, a coating layer of a cobalt compound (high-order cobalt oxide in which the average valence of cobalt is greater than two) such as cobalt oxyhydroxide having an average thickness of 10 nm or less is formed on the positive electrode active material.

The coating layer of the cobalt compound is also formed on a surface of the flake graphite. The coating layer on the flake graphite has a smaller thickness than the coating layer on the positive electrode active material.

The two cooling members 8, the positive module electrode 22, and the negative module electrode 32 are arranged on the electrode body, which has undergone the overdischarging step, and are fastened by the fasteners 9. This produces the nickel metal hydride battery 1.

In the description above, after the overdischarging step is performed on the electrode body, the nickel metal hydride battery 1 is produced. Instead, after the nickel metal hydride battery 1 is produced, the overdischarging step may be performed.

The operation of the present embodiment will now be described.

A case in which the overdischarging step is not performed in the method for producing the nickel metal hydride battery 1 will be described.

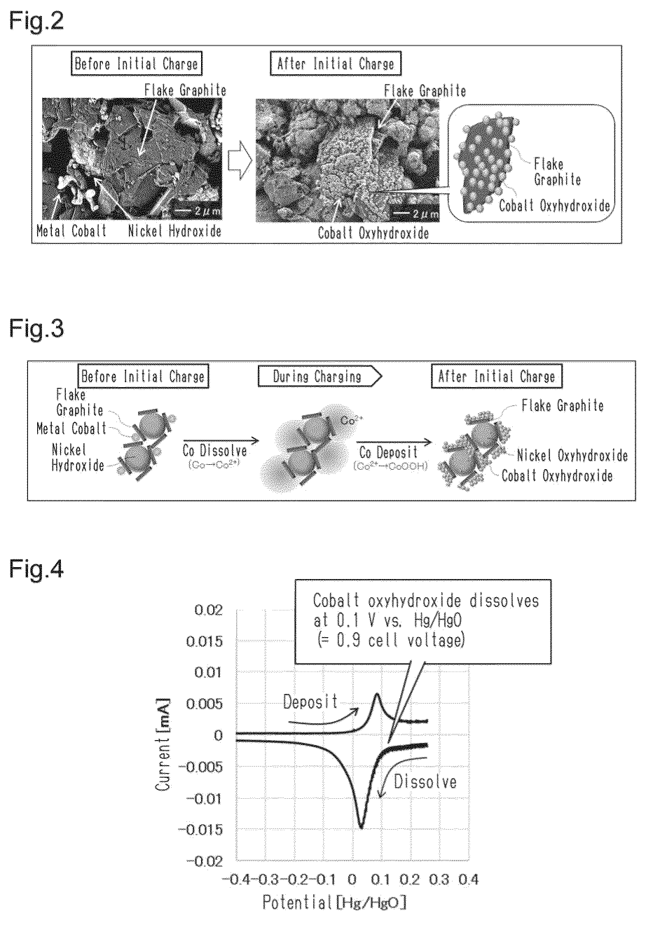

As shown in FIG. 2, the positive electrode active material layer includes a mixture of nickel hydroxide particles as the positive electrode active material, a cobalt compound such as metal cobalt, and flake graphite. In assembling the nickel metal hydride battery, when the electrolytic solution is added to the storage space, the metal cobalt is dissolved. When the initial charging is performed, cobalt hydroxide selectively deposits on the surface of the flake graphite, and the cobalt hydroxide is oxidized to produce cobalt oxyhydroxide having a high conductivity.

The mechanism of cobalt hydroxide selectively depositing on the surface of the flake graphite may be as follows.

As shown in FIG. 3, at the time of initial charging, when the nickel hydroxide particle is compared to the flake graphite in the positive electrode active material layer, the flake graphite has a higher conductivity than the nickel hydroxide particle. Cobalt hydroxide tends to deposit on a location where electrons readily flow. Therefore, cobalt hydroxide selectively deposits on the flake graphite. The concentration of cobalt ions (Co²⁺) decreases in the vicinity of the flake graphite. This further facilitates deposition of cobalt hydroxide on the flake graphite.

Next, a case in which the overdischarging step of the present embodiment is performed will be described.

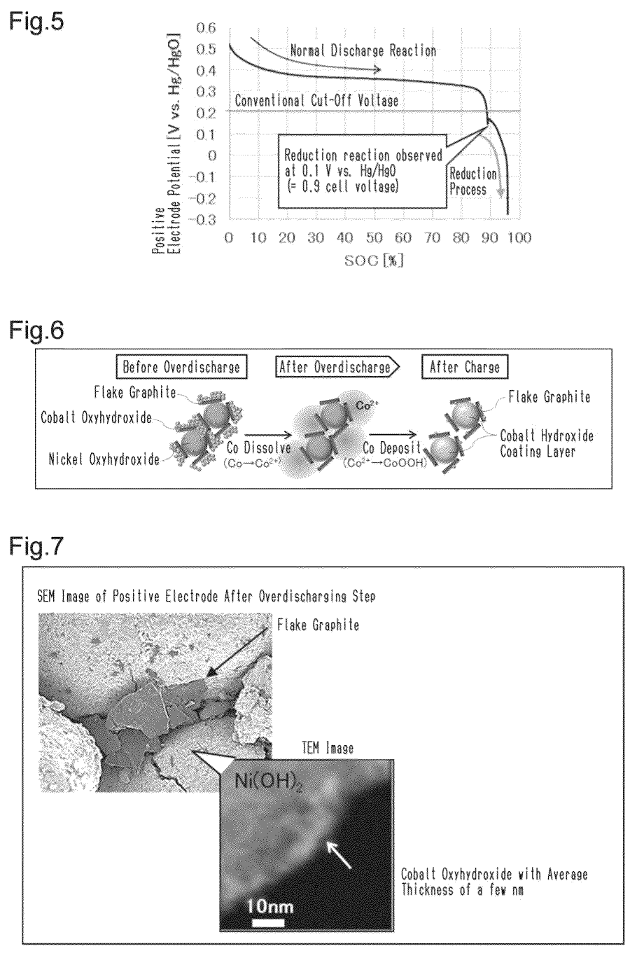

As shown in FIGS. 4 and 5, when the overdischarging step is performed to discharge so that the cell voltage becomes less than 1.0 V, cobalt oxyhydroxide is reduced and dissolved. After the overdischarging, when charging is again performed until the cell voltage exceeds 1 V, cobalt hydroxide selectively deposits on the positive electrode active material.

The mechanism of cobalt hydroxide selectively depositing on the positive electrode active material may be as follows.

As shown in FIG. 6, when the overdischarging step is performed, the flake graphite has a higher conductivity than the positive electrode active material. Thus, the positive electrode active material is likely to have a higher potential than the flake graphite. Cobalt hydroxide tends to deposit when the cell voltage is 1 V or higher, and thus is likely to deposit on the positive electrode active material, which has a higher potential. In the positive electrode active material layer, the content of the positive electrode active material is greater than the content of the flake graphite. Thus, in the positive electrode active material layer, the positive electrode active material has a relatively large surface area. Hence, as aggregation of cobalt hydroxide is limited, cobalt hydroxide deposits on the positive electrode active material to have a smaller thickness.

As shown in FIG. 7, the overdischarging step reduces deposition of cobalt hydroxide on the flake graphite. In addition, cobalt hydroxide selectively deposits on the surface of substantially all of the nickel hydroxide particles in contact with the electrolytic solution. This forms a cobalt oxyhydroxide layer having an average thickness that is less than or equal to 10 nm.

The effect of the present embodiment will now be described.

(1) The raw material composition including the positive electrode active material powder including nickel hydroxide, the cobalt compound, and the flake graphite is layered on the current collector. The positive electrode producing step is included to produce a positive electrode including the positive electrode active material layers 21 and 41 in which the content of the cobalt compound is less than or equal to 3 mass % and the R value is less than or equal to 0.4. The negative electrode producing step is included to layer a raw material composition including the negative electrode active material powder on the current collector to produce a negative electrode. The electrode body producing step is included to arrange the separator 5 between the positive electrode and the negative electrode and impregnate the separator 5 with an electrolytic solution to produce an electrode body. The overdischarging step is included to, after charging, overdischarge and again charge the electrode body.

The overdischarging step allows cobalt hydroxide to selectively deposit on the positive electrode active material. The cobalt hydroxide is oxidized so that the positive electrode active material is covered by cobalt oxyhydroxide having a high conductivity. This limits increases in the cell resistance while appropriately reducing the content of the cobalt compound included in the positive electrode active material layer.

(2) In the raw material composition, the average particle size of the flake graphite is greater than or equal to 0.4 times the average particle size of the positive electrode active material powder. Thus, when the raw material composition is kneaded, it is likely to avoid a situation in which the particle size of the flake graphite becomes excessively small compared to the particle size of the positive electrode active material powder.

(3) A positive electrode for a nickel metal hydride battery includes a current collector and a positive electrode active material layer. The positive electrode active material layer includes a positive electrode active material, a cobalt compound layer covering the positive electrode active material, and flake graphite. The content of the cobalt compound in the positive electrode active material layer is less than or equal to 3 mass %. In addition, the coverage of the cobalt compound layer on the positive electrode active material is greater than or equal to 50%. The positive electrode active material layer has a graphitization degree of 0.4 or less as measured by Raman spectroscopy.

Thus, while maintaining the function of the cobalt compound layer as the conductive additive, the content of the cobalt compound in the positive electrode active material layers 21 and 41 is appropriately reduced. In addition, an increase in the cell resistance caused by corrosion of the flake graphite is limited.

(4) The average particle size of the flake graphite is greater than or equal to 0.3 times the average particle size of the positive electrode active material.

The particle size of the flake graphite will not be excessively small compared to the particle size of the positive electrode active material. Thus, the flake graphite has a specified size. Therefore, in the positive electrode active material layers 21 and 41, the flake graphite extends over multiple particles of the positive electrode active material. In other words, the flake graphite is in contact with multiple particles of the positive electrode active material. This ensures a conductive path, thereby limiting an increase in the internal resistance of the positive electrode active material layers 21 and 41.

(5) The content of the flake graphite in the positive electrode active material layers 21 and 41 is greater than or equal to 3 mass % and less than or equal to 10 mass %. Thus, while maintaining the necessary amount of the positive electrode active material and the cobalt compound in the positive electrode active material layers 21 and 41, the conductivity is improved.

### MODIFIED EXAMPLES

The present embodiment may be modified as follows. The embodiment and the following modified examples can be combined within a range where the combined modified examples remain technically consistent with each other.

In the present embodiment, the method for producing the nickel metal hydride battery 1 includes the positive electrode producing step, the negative electrode producing step, the hyperbolic electrode producing step, the electrode body producing step, and the overdischarging step. However, there is no limitation to this configuration. The hyperbolic electrode producing step may be omitted. More specifically, the hyperbolic electrode 4 may be omitted from the nickel metal hydride battery 1, and the separator 5 may be sandwiched between the positive electrode 2 and the negative electrode 3 to form an electrode body.

In the present embodiment, the overdischarging step is performed as one of the steps in the method for producing the nickel metal hydride battery 1. However, there is no limitation to this configuration. The overdischarging step may be performed as a step in a method for producing the electrode body. That is, the overdischarging step may be performed as the method for producing the electrode body. Also, the overdischarging step may be performed as a step in a method for producing the positive electrode. When the overdischarging step is performed in the method for producing the positive electrode, a separate electrode body for the overdischarging step may be used. The positive electrode produced through the overdischarging step may be used to produce another electrode body and another nickel metal hydride battery.

### EXAMPLES

Specific examples of the embodiment described above will now be described.

### Example 1

Nickel hydroxide having an average particle size of 8 μm was used as the positive electrode active material.

Metal cobalt having an average particle size of 5 μm was used as the cobalt compound.

Flake graphite having an average particle size of 5 μm, an R value of 0.15, and a B.E.T specific surface area of 11.7 m²/g was used.

The nickel hydroxide, the metal cobalt, and the flake graphite described above were mixed to respectively have a solid content of 90.2 mass %, 1 mass %, and 6 mass %. As a binder, polyolefin and carboxymethyl cellulose were mixed to each have a 1 mass %. As an additive, zinc oxide and yttrium oxide were mixed to have 0.3 mass % and 0.5 mass % to produce the raw material composition. The mixture amount of the raw material composition is substantially fixed even after the positive electrode 2 is produced. That is, the mixture amount of the raw material composition is substantially the same as the amount contained in the positive electrode 2.

The raw material composition was kneaded using a known kneader. At the time of kneading, shearing force was 524 Pa. The kneaded raw material composition was applied to the current collector foil 20 and dried to produce the positive electrode 2.

In addition, the negative electrode producing step and the hyperbolic electrode producing step described above were performed to produce the negative electrode 3 and the hyperbolic electrode 4. The electrode body producing step described above was performed using the positive electrode 2, the negative electrode 3, and the hyperbolic electrode 4 to produce an electrode body. The produced electrode body was charged to 1.2 V and then overdischarged to 0.9 V. Subsequently, the electrode body was again charged to 1.2 V. The two cooling members 8, the positive module electrode 22, the negative module electrode 32, and the two fasteners 9 were used to produce a nickel metal hydride battery 1.

### Example 2

A nickel metal hydride battery 1 was produced using the same method as that used in Example 1 except that shearing force at the time of kneading the raw material composition was changed to 131 Pa.

### Example 3

A nickel metal hydride battery 1 was produced using the same method as that used in Example 1 except that shearing force at the time of kneading the raw material composition was changed to 1833 Pa.

### Example 4

A nickel metal hydride battery 1 was produced using the same method as that used in Example 1 except that the mixture amount of metal cobalt was 2 mass %, the mixture amount of nickel hydroxide was 89.2 mass %, the R value of the flake graphite was 0.18, and the shearing force at the time of kneading was changed to 100 Pa.

### Example 5

A nickel metal hydride battery 1 was produced using the same method as that used in Example 4 except that the flake graphite had an average particle size of 7 μm, an R value of 0.15, and a B.E.T specific surface area of 9.5 m²/g.

### Example 6

A nickel metal hydride battery 1 was produced using the same method as that used in Example 4 except that the average particle size of the flake graphite was 3 μm, the R value of the flake graphite was 0.20, and the B.E.T specific surface area was 16.4 m²/g.

### Example 7

A nickel metal hydride battery 1 was produced using the same method as that used in Example 1 except that the mixture amounts of nickel hydroxide, metal cobalt, and the flake graphite were set as shown in Table 1 and the shearing force of the kneading was set to 100 Pa.

### Example 8

A nickel metal hydride battery was produced using the same method as that used in Example 7 except that nickel hydroxide having an average particle size of 5 μm was used as the positive electrode active material.

### Example 9

A nickel metal hydride battery 1 was produced using the same method as that used in Example 7 except that nickel hydroxide having an average particle size of 14 μm was used as the positive electrode active material.

### Example 10

A nickel metal hydride battery 1 was produced using the same method as that used in Example 1 except that shearing force at the time of kneading was set to 100 Pa.

### Example 11

A nickel metal hydride battery 1 was produced in the same manner as in Example 10 except that the mixture amounts of nickel hydroxide, metal cobalt, and the flake graphite were set as shown in Table 1 and the mixture amount of carboxymethyl cellulose was set to 1.5 mass %.

### Example 12

A nickel metal hydride battery 1 was produced using the same method as that used in Example 10 except that the mixture amounts of nickel hydroxide, metal cobalt, and the flake graphite were set as shown in Table 1.

### Example 13

A nickel metal hydride battery 1 was produced using the same method as that used in Example 12 except that the flake graphite had an average particle size of 19 μm, an R value of 0.08, and a B.E.T specific surface area of 4.0 m²/g.

### Example 14

A nickel metal hydride battery 1 was produced using the same method as that used in Example 12 except that an antioxidant was used. As the antioxidant, IRGAFOS168 (manufactured by BASF Japan Ltd.), which is a commercially available phosphorus-based antioxidant, was used. The mixture amount of the antioxidant relative to the mixture amount of the flake graphite was set to 5 mass %. The flake graphite and the phosphorus-based antioxidant were dry-mixed in an air atmosphere while being heated to approximately 200° C. to cover the flake graphite with the antioxidant.

### Example 15

A nickel metal hydride battery 1 was produced using the same method as that used in Example 12 except that the R value of the flake graphite was set to 0.02. The flake graphite having an R value of 0.02 was prepared by heating the flake graphite of Example 1 at approximately 2800° C. in a nitrogen atmosphere.

### Comparative Example 1

A nickel metal hydride battery was produced using the same method as that used in Example 1 except that shearing force at the time of kneading the raw material composition was changed to 2618 Pa.

### Comparative Example 2

A nickel metal hydride battery was produced using the same method as that used in Example 1 except that shearing force at the time of kneading the raw material composition was changed to 2094 Pa.

### Comparative Example 3

A nickel metal hydride battery was produced using the same method as that used in Example 1 except that the overdischarging step was not performed on the produced electrode body.

### Comparative Example 4

A nickel metal hydride battery was produced using the same method as that used in Comparative Example 3 except that the mixture amounts of nickel hydroxide, metal cobalt, and the flake graphite were set as shown in Table 1.

Table 1 shows the average particle size of nickel hydroxide, metal cobalt, and flake graphite, the particle size ratio of metal cobalt and flake graphite, the mixture amount of a raw material, the graphitization degree of flake graphite, the B.E.T specific surface area of flake graphite, the value obtained by multiplying the R value and the B.E.T specific surface area for the raw material composition of Examples 1 to 15 and Comparative Examples 1 to 4. In Table 1, the values are respectively shown in the “Average Particle Size (μm)” column, the “Particle Size Ratio” column, the “Mixture Amount (wt %)” column, the “Flake Graphite R Value” column, the “BET Specific Surface Area (m²/g)” column, and the “R Value×BET Specific Surface Area” column.

Also, in Table 1, whether the antioxidant is present is shown in the “Antioxidant” column by ∘ indicating “presence” and × indicating “absence.” The shearing force at the time of kneading in a producing step is shown in the “Kneading Shearing Force (Pa)” column. Whether the overdischarging step is performed is shown in the “Overdischarging Step” column by ∘ indicating “performed” and × indicating “not performed.”

The B.E.T specific surface area was determined by measuring an adsorption-desorption isotherm with nitrogen gas using a specific surface area and pore size analyzer (QUADRASORB evo, manufactured by Anton Paar GmbH) and using a single-point method.

TABLE 1

| | Raw Material Composition | | | | | | | | | | | Producing Step | |
|---|---|---|---|---|---|---|---|---|---|---|---|---|---|
| | Average Particle | | | Particle | Mixture Amount | | | Flake | BET Specific | R Value × | | Kneading | Over- |
| | Size (μm) | | | Size Ratio | (wt %) | | | Graphite | Surface Area | BET Specific | Anti- | Shearing | discharging |
| | Ni | Co | C | C/Ni | Ni | Co | C | R Value | (m²/g) | Surface Area | oxidant | Force (Pa) | Step |
| Example 1 | 8 | 5 | 5 | 0.63 | 90.2 | 1 | 6 | 0.15 | 11.7 | 1.76 | X | 524 | ◯ |
| Example 2 | 8 | 5 | 5 | 0.63 | 90.2 | 1 | 6 | 0.15 | 11.7 | 1.76 | X | 131 | ◯ |
| Example 3 | 8 | 5 | 5 | 0.63 | 90.2 | 1 | 6 | 0.15 | 11.7 | 1.76 | X | 1833 | ◯ |
| Example 4 | 8 | 5 | 5 | 0.63 | 89.2 | 2 | 6 | 0.18 | 11.7 | 2.11 | X | 100 | ◯ |
| Example 5 | 8 | 5 | 7 | 0.38 | 89.2 | 2 | 6 | 0.15 | 9.5 | 1.43 | X | 100 | ◯ |
| Exampis 6 | 8 | 5 | 3 | 0.38 | 89.2 | 2 | 6 | 0.20 | 16.4 | 3.28 | X | 100 | ◯ |
| Example 7 | 8 | 5 | 5 | 0.63 | 85.2 | 2 | 10 | 0.15 | 11.7 | 1.76 | X | 100 | ◯ |
| Example 8 | 5 | 5 | 5 | 1.00 | 85.2 | 2 | 10 | 0.15 | 11.7 | 1.76 | X | 100 | ◯ |
| Example 9 | 14 | 5 | 5 | 0.36 | 85.2 | 2 | 10 | 0.15 | 11.7 | 1.76 | X | 100 | ◯ |
| Example 10 | 8 | 5 | 5 | 0.63 | 90.2 | 1 | 6 | 0.15 | 11.7 | 1.76 | X | 100 | ◯ |
| Example 11 | 8 | 5 | 5 | 0.63 | 90.2 | 0.5 | 6 | 0.15 | 11.7 | 1.76 | X | 100 | ◯ |
| Example 12 | 8 | 5 | 5 | 0.63 | 87.2 | 2 | 8 | 0.15 | 11.7 | 1.76 | X | 100 | ◯ |
| Exemple 13 | 8 | 5 | 19 | 2.38 | 87.2 | 2 | 8 | 0.08 | 4.0 | 0.32 | X | 100 | ◯ |
| Example 14 | 8 | 5 | 5 | 0.63 | 87.2 | 2 | 8 | 0.15 | 11.7 | 1.76 | ◯ | 100 | ◯ |
| Example 15 | 8 | 5 | 5 | 0.63 | 87.2 | 2 | 8 | 0.02 | 11.7 | 0.23 | X | 100 | ◯ |
| Comparative Example 1 | 8 | 5 | 5 | 0.63 | 90.2 | 1 | 6 | 0.15 | 11.7 | 1.76 | X | 2618 | ◯ |
| Comparative Example 2 | 8 | 5 | 5 | 0.63 | 90.2 | 1 | 6 | 0.15 | 11.7 | 1.76 | X | 2094 | ◯ |
| Comparative Example 3 | 8 | 5 | 5 | 0.63 | 90.2 | 1 | 6 | 0.15 | 11.7 | 1.76 | X | 100 | X |
| Comparative Example 4 | 8 | 5 | 5 | 0.63 | 89.2 | 2 | 6 | 0.15 | 11.7 | 1.76 | X | 100 | X |

TABLE 2

| | Positive Electrode | | | | | | |
|---|---|---|---|---|---|---|---|
| | | | Particle | R Value | 0.2-Sec | Charge- | 0° C., 5-Sec Cell |
| | Average Particle | | Size | of Positive | Call | Discharge | Resistance Increase |
| | Size (μm) | | Ratio | Electrode Active | Resistance | Efficiency | Amount (mΩ) (After-Before |
| | Ni | C | C/Ni | Material Layer | (mΩ) | (%) | 14000 km Durability Test) |
| Example 1 | 8 | 5 | 0.63 | 0.2 [symbol] | 0.39 | 96.0 | — |
| Example 2 | 8 | 5 | 0.63 | 0.25 | 0.40 | 96.0 | — |
| Example 3 | 8 | 3 | 0.38 | 0.38 | 0.45 | 94.3 | — |
| Example 4 | 8 | 5 | 0.63 | 0.20 | 0.43 | 96.4 | 1.82 |
| Example 5 | 8 | 7 | 0 [symbol] 88 | 0.17 | 0.44 | 96.3 | — |
| Example 6 | 8 | 3 | 0.38 | 0.22 | 0.48 | 96.3 | — |
| Example 7 | 8 | 5 | 0.63 | 0.25 | 0.29 | 97.5 | — |
| Example 8 | 5 | 5 | 1.00 | 0.25 | 0.36 | 96.6 | — |
| Example 9 | 14 | 5 | 0.36 | 0.25 | 0.47 | 96.3 | — |
| Example 10 | 8 | 5 | 0.63 | 0.25 | 0.41 | 96.3 | — |
| Example 11 | 8 | 5 | 0.63 | 0.25 | 0.41 | 95.5 | — |
| Example 12 | 8 | 5 | 0.63 | 0.25 | 0.37 | 97.0 | 0.70 |
| Exemple 13 | 8 | 19 | 2.38 | 0.10 | 0.47 | 96.7 | 0.28 |
| Example 14 | 8 | 5 | 0.63 | 0.25 | 0.40 | 97.7 | 0.05 |
| Example 15 | 8 | 5 | 0.63 | 0.25 | 0.37 | 97.0 | 0.05 |
| Comparative Example 1 | 8 | 0.5 | 0.06 | 0.41 | 0.62 | 94.3 | — |
| Comparative Example 2 | 8 | 0.5 | 0.06 | 0.42 | 0.58 | 94.5 | — |
| Comparative Example 3 | 8 | 5 | 0.63 | 0.25 | 0.42 | 90.8 | — |
| Comparative Example 4 | 8 | 5 | 0.63 | 0.25 | 0.42 | 91.3 | — |

[symbol]

indicates data missing or illegible when filed

The nickel metal hydride batteries of Examples 1 to 15 and Comparative Examples 1 to 4 were evaluated as follows.

### Average Particle Size and Particle Size Ratio

The average particle sizes of the positive electrode active material and the flake graphite included in the positive electrode active material layers 21 and 41 were measured using a known scanning electron microscope. Fifty particles were randomly measured to calculate an average particle size D50 using the long side of the flake graphite as the particle size. The results are shown in the “Average Particle Size (μm)” column and the “Particle Size Ratio” column in Table 2.

### GraphitizationDegree of Positive Electrode Active Material Layer

The positive electrode active material layers 21 and 41 were measured by a known Raman spectrometer. The graphitization degree was calculated from the obtained Raman spectra using the above method. The results are shown in the “R Value of Positive Electrode Active Material Layer” column in Table 2.

Measurement conditions of Raman spectroscopic analysis using a Raman spectrometer are as follows.
Apparatus: Raman-11 (Nanophoton Corporation)
Measurement Mode: XY-Average
Objective Lens: 50 Times
Laser Wavelength: 532 nm
Laser Output: 0.2 mW
Measurement Time: 3 Seconds
Diffraction Grating: 300 gr/mm
Measurement Temperature: Room Temperature
Measurement Atmosphere: Ambient Air

### Average Thickness and Coverage of Cobalt Compound Layer Covering Positive Electrode Active Material

The average thickness and the coverage of the cobalt compound layer covering the positive electrode active material were measured by observation using TEM-EELS or the like.

### Cell Resistance

The cell resistance was measured when discharging was performed for 0.2 seconds at 25° C. with the state of charge (SOC) of 60%. The results were shown in the “0.2-Sec Cell Resistance (mΩ)” column in Table 2.

### Charge-Discharge Efficiency

The nickel metal hydride batteries of Examples 1 to 15 and comparative examples 1 to 4 were charged to the SOC of 100% at 1/3 C rate then discharged at 1/3 C rate to 1.0 V at a temperature of 25° C. The charge-discharge efficiency of each nickel metal hydride battery was calculated using the following equation.

Charge-Discharge Efficiency (%)=100×(Discharge Capacity)/(Charge Capacity)

The results are shown in the “Charge-Discharge Efficiency (%)” column in Table 2.

The nickel metal hydride batteries of Examples 4 and 12 to 15 were further evaluated as follows.

### Cell Resistance Increase Amount

The cell resistance was measured before and after a 14000-km durability test to obtain a cell resistance increase amount. The cell resistance was measured after five seconds of discharging at 0° C. with the state of charge (SOC) of 60%, which were set as the measurement conditions. The results are shown in the column of the “0° C., 5-Sec Cell Resistance Increase Amount (mΩ) (After-Before 14000 km Durability Test)” in Table 2.

### Evaluation Results

In Comparative Examples 1 and 2, the average particle size of the flake graphite in the positive electrode active material layer was 0.5 μm and small. It is considered that the flake graphite was broken into small pieces due to the high shearing force during the kneading. The flake graphite is less likely to be in contact with multiple particles of the positive electrode active material. This may be the cause of an increase in the cell resistance. Since the flake graphite was broken into small pieces, the graphitization degree of the positive electrode active material layer was greater than 0.4.

In Comparative Examples 3 and 4, in which the overdischarging step was not performed, the cobalt compound layer deposited mainly on the flake graphite to have an average thickness greater than 10 nm. The coverage of the cobalt compound layer on the positive electrode active material was approximately 30%.

In Examples 1 to 15 and Comparative Examples 1 and 2, the average thickness of the cobalt compound layer was less than or equal to 10 nm and the coverage was greater than or equal to 70%.

In each of Examples 1 to 15, the average particle size of the flake graphite in the positive electrode active material layers 21 and 41 was greater than or equal to 3 μm, that is, the flake graphite was not broken into small pieces. Since the flake graphite is more likely to be in contact with multiple particles of the positive electrode active material, the cell resistance was low. In each Examples 1 to 15, the graphitization degree of the positive electrode active material layers 21 and 41 was less than or equal to 0.4. The reactivity of the positive electrode active material layers 21 and 41 was low because of the low rate of bonding deficit.

In addition, the cell resistance was further reduced because the particle size ratio of the nickel hydroxide and the flake graphite was greater than or equal to 0.3. In Examples 1 to 15, the charge-discharge efficiency was greater than or equal to 94% and was considered to be satisfactory.

In Example 12, the R value of the flake graphite was smaller than that in Example 4. That is, the flake graphite having increased graphitization was used. Increased graphitization decreases the reactivity of the flake graphite. Thus, the cell resistance increase amount was small.

In Example 13, the flake graphite had a larger average particle size, a smaller B.E.T specific surface area, and a smaller R value than that of Example 12. The value obtained by multiplying the R value and the B.E.T specific surface area was 0.32. In general, there is a tendency that as the average particle size of the flake graphite is increased or as the B.E.T specific surface area is decreased, graphitization is increased. As graphitization is further increased, the flake graphite is less reactive. Thus, the cell resistance increase amount was small.

Example 14 differs from Example 12 in that an antioxidant was used. The use of the antioxidant decreases the reactivity of the flake graphite. Thus, the cell resistance increase amount was small.

In Example 15, the flake graphite having undergone heat treatment was used. The R value was smaller and graphitization was increased more than that in Example 12. The value obtained by multiplying the R value and the B.E.T specific surface area was 0.23. The reactivity of the flake graphite was further decreased. Thus, the cell resistance increase amount was small.

### REFERENCE SIGNS LIST

1) nickel metal hydride battery, 2) positive electrode, 3) negative electrode, 4) hyperbolic electrode, 5) separator, 6) sealing member, 7) outer frame, 8) cooling member, 9) fastener, 20) current collector foil, 21) positive electrode active material layer, 22) module positive electrode, 30) current collector foil, 31) negative electrode active material layer, 32) module negative electrode, 40) current collector foil, 41) positive electrode active material layer, 42) negative electrode active material layer, 80) through hole

1. A method for producing a nickel metal hydride battery, the method comprising:
a positive electrode producing step of layering a raw material composition, the raw material composition including a positive electrode active material powder containing nickel hydroxide, a cobalt compound, and flake graphite, on a current collector to produce a positive electrode including a positive electrode active material layer in which a content of the cobalt compound is less than or equal to 3 mass % and a graphitization degree is less than or equal to 0.4 as measured by Raman spectroscopy;
a negative electrode producing step of layering a raw material composition including a negative electrode active material powder on a current collector to produce a negative electrode;
an electrode body producing step of arranging a separator between the positive electrode and the negative electrode and impregnating the separator with an electrolytic solution to produce an electrode body; and
an overdischarging step of, after charging the electrode body, overdischarging the electrode body, and again charging the electrode body.

2. The method according to claim 1, wherein in the raw material composition, an average particle size of the flake graphite is greater than or equal to 0.4 times an average particle size of the positive electrode active material powder.

3. A positive electrode for a nickel metal hydride battery, the positive electrode comprising:
a current collector; and
a positive electrode active material layer, wherein
the positive electrode active material layer includes a positive electrode active material, a cobalt compound layer covering the positive electrode active material, and flake graphite,
a content of a cobalt compound in the positive electrode active material layer is less than or equal to 3 mass %,
a coverage of the cobalt compound layer on the positive electrode active material is greater than or equal to 50%, and
the positive electrode active material layer has a graphitization degree that is less than or equal to 0.4 as measured by Raman spectroscopy.

4. The positive electrode according to claim 3, wherein the cobalt compound layer has an average thickness that is less than or equal to 10 nm.

5. The positive electrode according to claim 3, wherein an average particle size of the flake graphite is greater than or equal to 0.3 times an average particle size of the positive electrode active material.

6. The positive electrode according to claim 3, wherein a content of the flake graphite in the positive electrode active material layer is greater than or equal to 3 mass % and less than or equal to 10 mass %.

7. The positive electrode according to claim 3, wherein the cobalt compound layer is further formed on a surface of the flake graphite.

8. A nickel metal hydride battery, comprising:
the positive electrode according to claim 3.
